(19) United States
(12) Patent Application Publication
(10) Pub. No.: US 2017/0035632 A1
(43) Pub. Date: Feb. 9, 2017

(54) SYNCHRONIZED MOTION CONTROL SYSTEM AND METHOD FOR DOUBLE ELECTRIC BED

(71) Applicant: Chuan-Hang SHIH, CHANGHUA COUNTY (TW)

(72) Inventor: Chuan-Hang SHIH, CHANGHUA COUNTY (TW)

(21) Appl. No.: 14/954,314

(22) Filed: Nov. 30, 2015

(30) Foreign Application Priority Data
Aug. 4, 2015 (TW) 104125180

(51) Int. Cl. A61G 7/018; G05B 15/02; A61G 7/015

(52) U.S. Cl. CPC A61G 7/018; A61G 7/015; G05B 15/02

(57) ABSTRACT

A synchronized motion control system for a double electric bed includes two control devices attached to two electric single beds of the double electric bed respectively. Each electric single bed has a driver circuit and a motor. Each control device has a Hall sensor for generating a Hall signal of the motor, a microcontroller electrically connected with the Hall sensor for generating a rotation number signal according to the Hall signal, and a communication unit electrically connected with the microcontroller. The communication units are electrically connected with each other. The microcontroller of one of the control devices compares the two rotation number signals to generate a difference signal. The motor corresponding to the larger rotation number signal is decelerated according to the difference signal, so as to make the two electric single beds perform synchronized motion.

### BACKGROUND

1. Technical Field

The present invention relates to a double electric bed, and more particularly, to a synchronized motion control system and a synchronized motion control method for a double electric bed.

2. Description of Related Art

Electric beds are commonly seen in hospitals and rehabilitation centers to serve as medical beds and rehabilitation beds. In general, the bed plates of the electric beds for supporting the users' back and/or legs can be lift by swinging upwardly, so as to change the user's posture for better comfort. As people pay more and more attention in life quality, more and more electric beds are used in general home life to replace the conventional double beds. A double electric bed usually includes two electric single beds located at the left and the right, respectively. For preventing the swinging motion of one of the electric single beds from affecting the user on the other electric single bed, the conventional double electric bed has two sets of driver circuit and motor installed at the two electric single beds, respectively. If the two electric single beds are required to move synchronously, thereby the two motors work with equal operating voltages, the two motors are still liable to rotate in different speeds because the two electric single beds may have unequal mechanical resistances or the users thereof are of unequal weight, so that the swinging motions of the two electric single beds are not synchronized. In such situation, the two electric single beds performing the non-synchronized motions have a gap therebetween, thereby increased in the risk of hurting the user; besides, the motion of the double electric bed looks not fine but rough, thereby hard to impress and attract the user. Therefore, it is an anxious problem for the dealers in the industry that how to make the two electric single beds perform synchronized motions when the double electric bed is set in a synchronized motion mode.

### SUMMARY

To solve the above-mentioned problem, an objective of the present invention is to provide synchronized motion control system and method which enable a double electric bed to perform synchronized motion.

To attain the above objective, the present invention provides a synchronized motion control system for a double electric bed. The double electric bed includes two electric single beds each having a driver circuit and a motor controlled by the driver circuit to drive motion of the electric single bed. The synchronized motion control system includes two control devices attached to the electric single beds respectively, and each having a Hall sensor, a microcontroller and a communication unit. The Hall sensor is adapted for being disposed in the motor of the electric single bed for generating a Hall signal which corresponds to rotation of the motor. The microcontroller is electrically connected with the Hall sensor for generating a rotation number signal according to the Hall signal. The rotation number signal indicates accumulative changing times of the Hall signal. The communication unit is electrically connected with the microcontroller for receiving the rotation number signal. The communication units of the control devices are electrically connected with each other, thereby enabling the microcontroller of one of the control devices to receive the rotation number signal of the other control device and compare the two rotation number signals to generate a difference signal. The microcontrollers are adapted for being electrically connected with the driver circuits of the electric single beds to output the difference signal to the driver circuit of the electric single bed which corresponds to the larger one of the rotation number signals, so that the driver circuit, which receives the difference signal, decelerates its corresponding motor by decreasing output voltage according to the difference signal.

To attain the above objective, the present invention also provides a synchronized motion control method for a double electric bed. The double electric bed includes two electric single beds each having a driver circuit and a motor controlled by the driver circuit to drive motion of the electric single bed. The synchronized motion control method includes the steps of: (A) providing two Hall sensors located at the two motors respectively, and providing two microcontrollers electrically connected with the two Hall sensors respectively, wherein the two Hall sensors are adapted for generating two Hall signals which corresponds to rotations of the motors respectively; (B) using the two microcontrollers to calculate two rotation number signals according to the two Hall signals respectively, wherein the rotation number signals indicate accumulative changing times of the two Hall signals respectively; and (C) using one of the microcontrollers to determine whether the two rotation number signals are equal to each other, if the two rotation number signals are not equal to each other, controlling the driver circuits to decelerate the motor which corresponds to the larger one of the two rotation number signals.

To attain the above objective, the present invention further provides a synchronized motion control method for a double electric bed. The double electric bed includes two electric single beds each having a driver circuit and a motor controlled by the driver circuit to drive motion of the electric single bed. The synchronized motion control method includes the steps of: (A) providing two control devices attached to the electric single beds respectively, wherein each of the two control devices includes a Hall sensor, a microcontroller electrically connected with the Hall sensor, and a communication unit electrically connected with the microcontroller; the Hall sensors are disposed in the motors of the electric single beds respectively for generating two Hall signals which corresponds to rotations of the motors respectively; the microcontrollers are electrically connected with the driver circuits of the electric single beds respectively; the communication units of the control devices are electrically connected with each other; (B) using the two microcontrollers to generate two rotation number signals according to the two Hall signals respectively, and using the communication units to receive the rotation number signals from the microcontrollers respectively and transmit the rotation number signals to each other, wherein the rotation number signals indicate accumulative changing times of the two Hall signals respectively; (C) using one of the microcontrollers to compare the two rotation number signals to generate a difference signal; and (D) if the difference signal is not equal to zero, using the microcontroller used in the step (C) to output the difference signal to the driver circuit of the electric single bed which corresponds to the larger one of the rotation number signals and using the driver circuit, which receives the difference signal, to decelerate its corresponding motor by decreasing output voltage according to the difference signal.

Therefore, the synchronized motion control system and method for the double electric bed control the two motors to decelerate according to the result of comparing the two rotation number signals until the two rotation number signals are equal to each other, so as to achieve the objective of making the double electric bed perform synchronized motion. The system and method of the present invention are capable of not only avoiding the current overload caused by accelerating the motor, but also enabling the double electric bed to operate in relatively higher rotary speed when the synchronized motion of the double electric bed is not required.

### BRIEF DESCRIPTION OF THE DRAWINGS

FIG. 1 is a block diagram of a system of the present invention;

FIGS. 2-3 are flow charts illustrating the operation of the present invention;

FIG. 4 is a schematic perspective view of a double electric bed using the system of the present invention; and

FIG. 5 is a schematic perspective view of an electric single bed of the double electric bed using the system of the present invention, in different direction from FIG. 4.

### DESCRIPTION OF THE EXEMPLARY EMBODIMENTS

First of all, when it is mentioned in the present invention that a device or unit is electrically connected with another device or unit, or two devices or units are electrically connected with each other, it means the devices or units are in a wired or wireless electrical connection, therefore the devices or units can transmit data signals to each other.

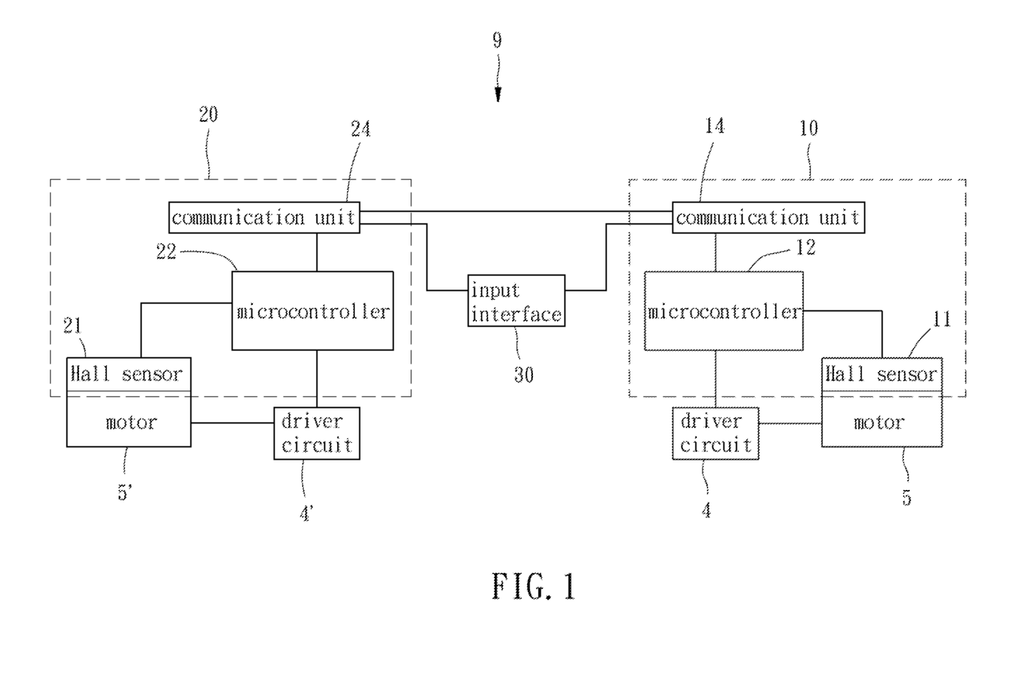

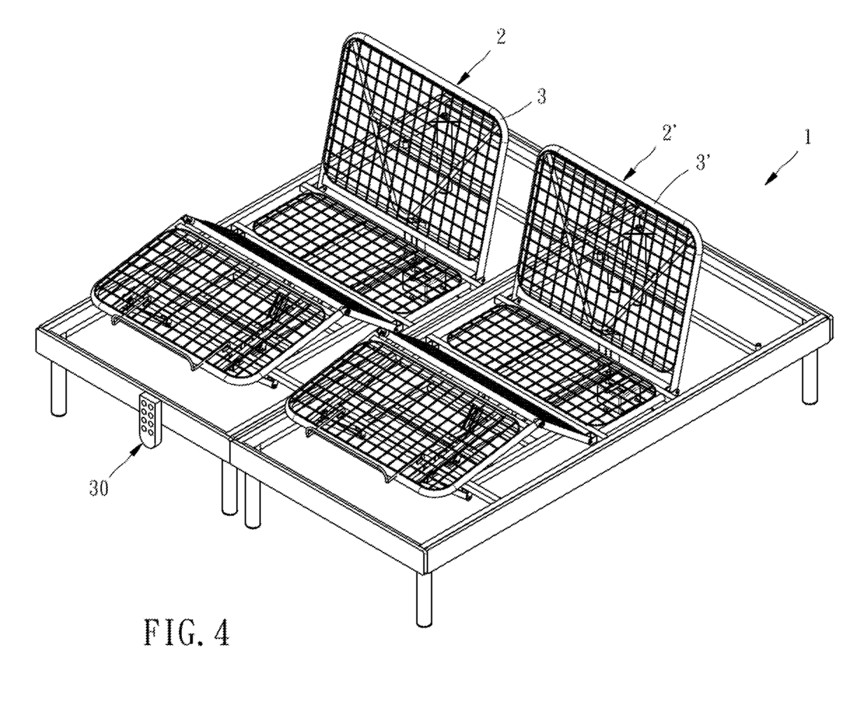

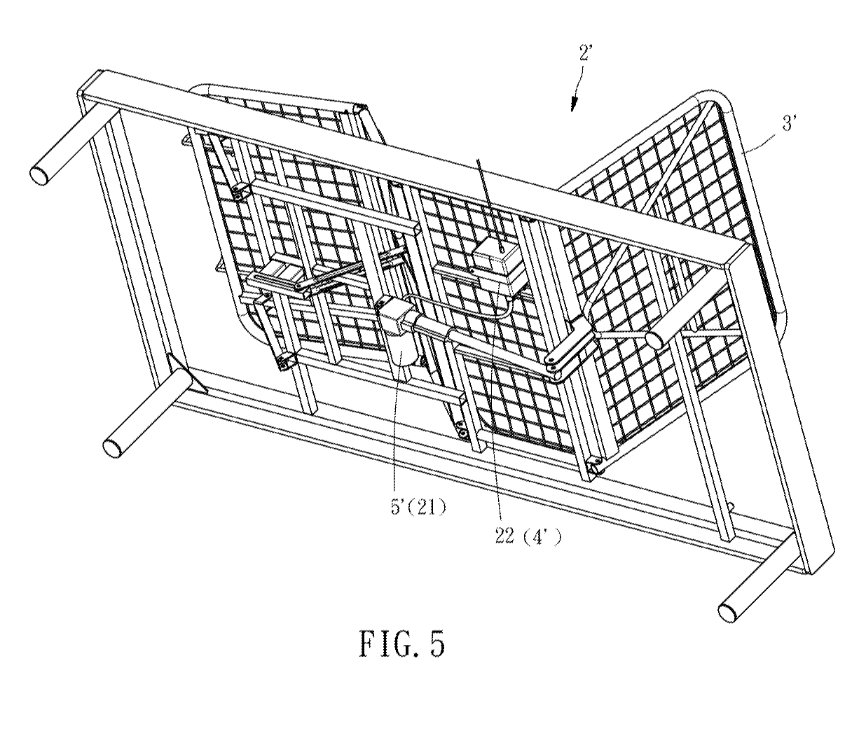

A synchronized motion control system 9 according to a preferred embodiment of the present invention, as shown in FIG. 1, is equipped in a double electric bed 1 as shown in FIGS. 4-5. The double electric bed 1 includes two electric single beds 2 and 2′ each having a movable back plate 3, 3′, a driver circuits 4, 4′, and a motor 5, 5′ controlled by the driver circuit 4, 4′ to drive the movable back plate 3, 3′ of the electric single bed 2, 2′ to swing. The synchronized motion control system 9 for the double electric bed 1 includes two control devices 10 and 20, and an input interface 30, as shown in FIG. 1. The two control devices 10 and 20 are attached to the electric single beds 2 and 2′ respectively, and each have a Hall sensor 11, 21, a microcontroller 12, 22, and a communication unit 14, 24. The input interface 30 is electrically connected with the communication units 14 and 24 of the two control devices 10 and 20, respectively. Referring to FIGS. 1 and 5, it should be noted that the driver circuits 4 and 4′ are not included in the synchronized motion control system 9 of the present invention, but in practice the driver circuits 4 and 4′ are disposed adjacent to the microcontrollers 12 and 22 respectively and located in the same mechanisms with the microcontrollers 12 and 22, respectively. On the other hand, the Hall sensors 11 and 21 are included in the synchronized motion control system 9 of the present invention, but in practice the Hall sensors 11 and 21 are disposed in the motors 5 and 5′ respectively, not disposed in the same mechanisms with the microcontrollers 12 and 22 respectively.

The Hall sensors 11 and 21 are disposed in the motors 5 and 5′ of the electric single beds 2 and 2′ respectively for generating two Hall signals which vary periodically along with rotations of the motors 5 and 5′ respectively, therefore the Hall signals correspond to the rotations of the motors 5 and 5′, respectively. Each of the motors 5 and 5′ is a permanent magnet DC brush motor, and the technology for the disposal of the Hall sensors 11 and 21 in the motors 5 and 5′ is available from the records of the related prior arts.

The microcontrollers 12 and 22 are electrically connected with the Hall sensors 11 and 21 respectively for generating two rotation number signals according to the Hall signals, respectively. The rotation number signals indicate accumulative changing times of the Hall signals, respectively. For example, the rotation number signal may be the accumulative changing times of the Hall signal in a period of time, such as 10 seconds. Alternately, the rotation number signal may be the summation of the last rotation number signal and a predetermined number of the accumulative changing times of the Hall signal; for example, the predetermined number may be 10, this means the rotation number signal is renewed in the interval of the Hall signal increasing or decreasing for 10 times, and the rotation number signal is renewed in a way that the last rotation number signal is increased or decreased by 10 to be the new rotation number signal.

The communication units 14 and 24 are electrically connected with the microcontrollers 12 and 22 respectively for receiving the rotation number signals.

The communication units 14 and 24 of the two control devices 10 and 20 are electrically connected with each other, thereby enabling the microcontroller of one of the control devices to receive the rotation number signal of the other control device and compare the two rotation number signals to generate a difference signal. For example, the microcontroller 22 of the control device 20 receives the rotation number signal of the control device 10 through the two communication units 14 and 24 which are electrically connected with each other, and compares the two rotation number signals to generate a difference signal which is equal or proportional to the difference between the two rotation number signals.

The microcontrollers 12 and 22 are electrically connected with the driver circuits 4 and 4′ of the electric single beds 2 and 2′ respectively for outputting the difference signal to the driver circuit of the electric single bed which corresponds to the larger one of the two rotation number signals. For example, the driver circuit 4′ electrically connected with the microcontroller 22 generates a pulse width modulation (PWM) signal according to the difference signal, to decelerate the motor 5′ driven by the driver circuit 4′ by decreasing output voltage.

Alternatively, the microcontroller 12 of the control device 10 may receive the rotation number signal of the control device 20 through the two communication units 14 and 24 which are electrically connected with each other and compare the two rotation number signals to generate the difference signal, and the driver circuit 4 electrically connected with the microcontroller 12 decelerates its corresponding motor 5, i.e. the motor 5 driven by the driver circuit 4, by decreasing output voltage according to the difference signal.

The input interface 30 electrically connected with the communication units 14 and 24 of the control devices 10 and 20 is a remote controller for the user to set the swinging angles or locations of the movable back plates 3 and 3′ of the electric single beds 2 and 2′, and select the way of the microcontroller calculating the rotation number signal. For example, when the input interface 30 is set to lift the movable back plates 3 and 3′, the input interface 30 transmits an input signal to the communication units 14 and 24, and the microcontrollers 12 and 22 respectively drive the motors 5 and 5′ to rotate forwardly according to the input signal; meanwhile, the microcontrollers 12 and 22 respectively renew the rotation number signals by adding the accumulative changing times of the Hall signals in the aforesaid process to the original rotation number signals. In contrast, when the input interface 30 is set to lower the movable back plates 3 and 3′, the microcontrollers 12 and 22 respectively drive the motors 5 and 5′ to rotate backwardly according to the input signal from the input interface 30 and meanwhile respectively renew the rotation number signals by subtracting the accumulative changing times of the Hall signals in the aforesaid process from the original rotation number signals.

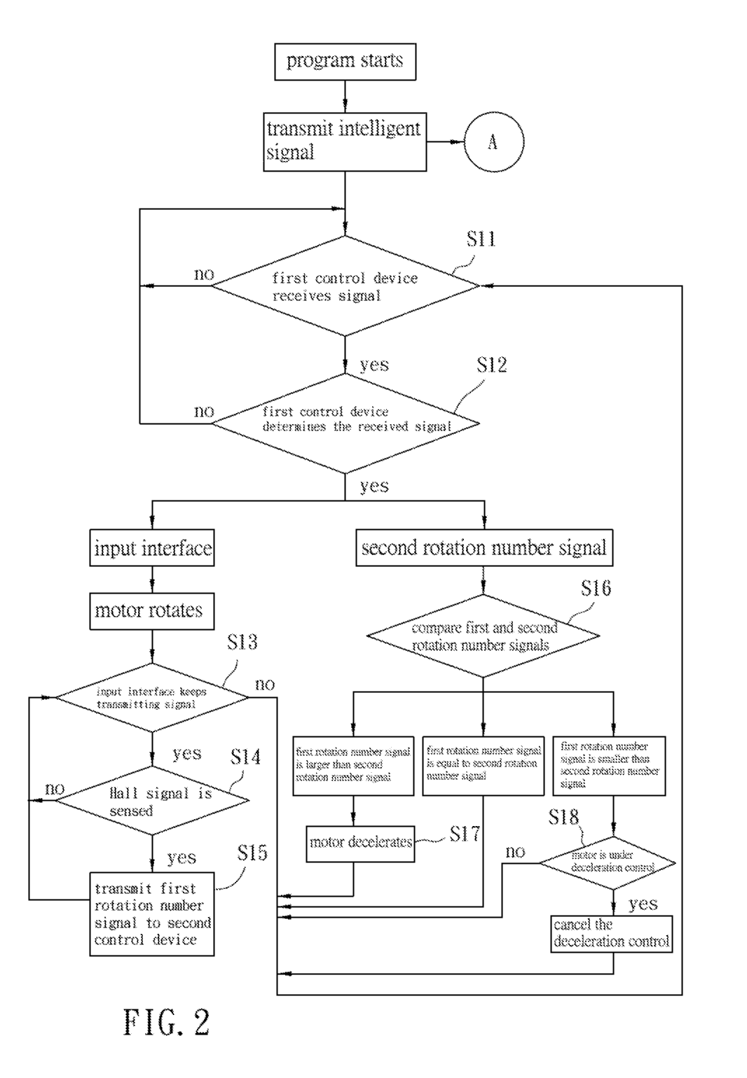

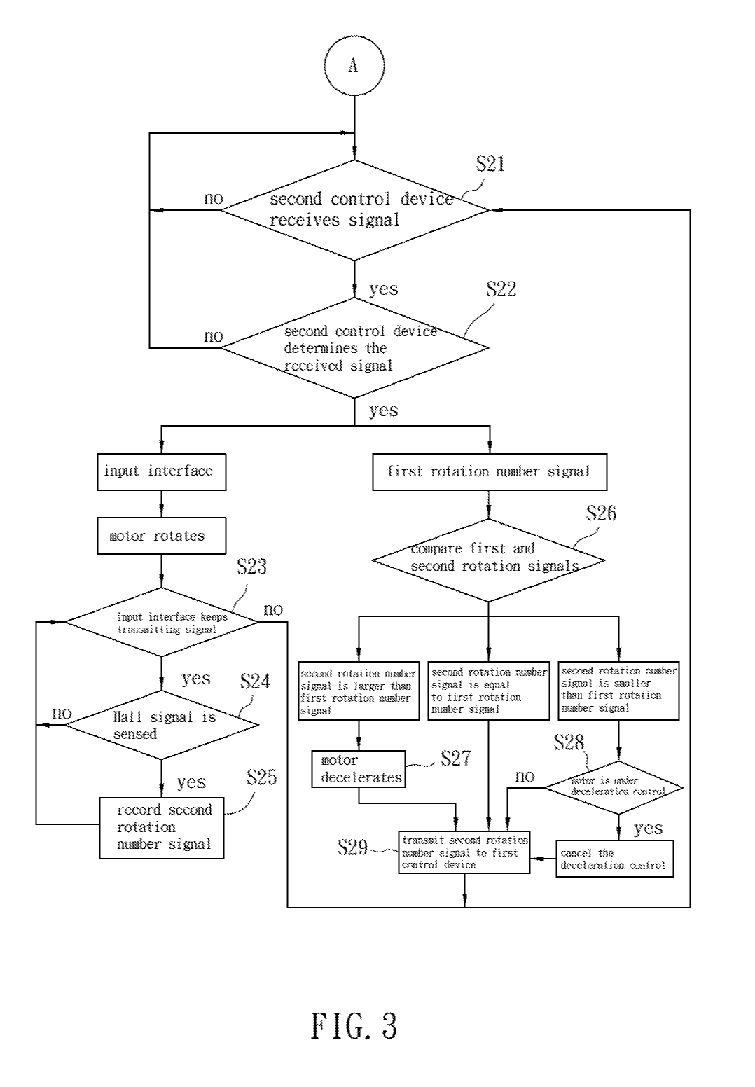

The operation of the synchronized motion control system 9 is described below and illustrated in FIGS. 2 and 3. At first, the two electric single beds 2 and 2′ of the double electric bed 1 are turned on at the same time, and the synchronized motion control system 9 autonomously determines one of the control devices to perform a first group of steps S11 to S18 as shown in FIG. 2, and the other control device to perform a second group of steps S21 to S29 as shown in FIG. 3. The way of the above determination is described below. Assuming that the two control devices are first and second control devices, the first and second control devices respectively and randomly transmit an intelligent signal to each another. If the first control device takes the lead of transmitting the intelligent signal and does not receive a response signal to the intelligent signal from the second control device in a period of time, the first control device enters a wait stage, stops transmitting a next intelligent signal and is prepared to perform the first group of steps S11 to S18. The second control device also transmits an intelligent signal to the first control device, and the first control device, which is already in the wait stage, transmits a response signal to the second control device. When receiving the response signal, the second control device stops transmitting a next intelligent signal and is prepared to perform the second group of steps S21 to S29. Of course, if the second control device takes the lead of transmitting the intelligent signal, the second control device is prepared to perform the first group of steps S11 to S18 and the first control device is prepared to perform the second group of steps S21 to S29. If the two electric single beds are not turned on at the same time, the control device of the electric single bed which is turned on earlier is set to perform the first group of steps S11 to S18.

For the convenience of description, in the following contents the control device 10 is set to perform the first group of steps and referred to as the first control device 10, and the control device 20 is set to perform the second group of steps and referred to as the second control device 20. At first, the communication unit 14 of the first control device 10 performs the step S11 to determine whether any signal is received; if no, the step S11 is repeated; if yes, the microcontroller 12 of the first control device 10 performs the step S12 to determine whether the received signal is transmitted from the input interface 30 or the second control device 20. If the received signal is not transmitted from the input interface 30 or the second control device 20, but from another device such as an unrelated remote controller, the step S11 is repeated.

If it is determined in the step S12 that the received signal is transmitted from the input interface 30, the microcontroller 12 of the first control device 10 controls the driver circuit 4 to drive the motor 5 to rotate in a preset speed, and then the communication unit 14 of the first control device 10 performs the step S13 to determine whether the input interface 30 keeps transmitting the signal; if no, the step S11 is repeated; if yes, the microcontroller 12 of the first control device 10 performs the step S14 to determine whether the Hall signal generated from the Hall sensor 11 by detecting the motor 5 is sensed; if no, the step S13 is repeated; if yes, the step S15 is performed, wherein the microcontroller 12 of the first control device 10 calculates a first rotation number signal according to the Hall signal, and the communication unit 14 of the first control device 10 receives the first rotation number signal and transmits the first rotation number signal to the communication unit 24 of the second control device 20. After that, the step S13 is repeated.

If it is determined in the step S12 that the received signal is a second rotation number signal from the second control device 20, which will be specified in the following contents, the microcontroller 12 of the first control device 10 calculates a first rotation number signal according to the received Hall signal, and performs the step S16 to compare the first rotation number signal with the second rotation number signal. If the first rotation number signal is larger than the second rotation number signal, the microcontroller 12 of the first control device 10 outputs a difference signal, which is equal or proportional to the difference between the first rotation number signal and the second rotation number signal, to the driver circuit 4. The driver circuit 4 performs the step S17 to generate a pulse width modulation signal according to the difference signal to decelerate the motor 5 by decreasing output voltage. The larger the difference signal is, the more the output voltage is decreased. After that, the step S11 is repeated. If the first rotation number signal is equal to the second rotation number signal, the microcontroller 12 of the first control device 10 does not control the driver circuit 4, which is electrically connected thereto, to decelerate the motor 5, so that the motor 5 keeps its rotary speed without being decelerated. After that, the step S11 is repeated. If the first rotation number signal is smaller than the second rotation number signal, the microcontroller 12 of the first control device 10 performs the step 18 to determine whether another difference signal has been outputted to the driver circuit 4 to make the motor 5 in a deceleration control; if no, the step S11 is repeated; if yes, the microcontroller 12 cancels the deceleration control to stop decelerating the motor 5, and the motor 5 rotates in the rotary speed before the deceleration control. After that, the step S11 is repeated until the first rotation number signal is equal to the second rotation number signal or the electric single beds 2 and 2′ reach the target locations.

While the first control device 10 performs the step S11, the communication unit 24 of the second control device 20 performs the step S21 to determine whether any signal is received; if no, the step S21 is repeated; if yes, the microcontroller 22 of the second control device 20 performs the step S22 to determine whether the received signal is transmitted from the input interface 30 or the first control device 10. If the received signal is not transmitted from the input interface 30 or the first control device 10, the step S21 is repeated.

If it is determined in the step S22 that the received signal is transmitted from the input interface 30, the microcontroller 22 of the second control device 20 controls the driver circuit 4′ to drive the motor 5′ to rotate in a preset speed. After that, the communication unit 24 of the second control device 20 performs the step S23 to determine whether the input interface 30 keeps transmitting the signal; if no, the step S21 is repeated; if yes, the microcontroller 22 of the second control device 20 performs the step S24 to determine whether the Hall signal generated from the Hall sensor 21 by detecting the motor5′ is sensed; if no, the step S23 is repeated; if yes, the microcontroller 22 of the second control device 20 performs the step S25 to calculate a second rotation number signal according to the Hall signal and recording the second rotation number signal. After that, the step S23 is repeated.

If it is determined in the step S22 that the received signal is transmitted from the first control device 10, the microcontroller 22 of the second control device 20 calculates a second rotation number signal according to the Hall signal corresponding to the motor 5′, and performs the step S26 to compare the first rotation number signal with the second rotation number signal. If the second rotation number signal is larger than the first rotation number signal, the microcontroller 22 of the second control device 20 outputs a difference signal to the driver circuit 4′. The driver circuit 4′ performs the step S27 to generate a pulse width modulation signal according to the difference signal to decelerate the motor 5′ by decreasing output voltage. After that, the communication unit 24 of the second control device 20 performs the step S29 to transmit the second rotation number signal to the first control device 10. After that, the step S21 is repeated. If the first rotation number signal is equal to the second rotation number signal, the microcontroller 22 of the second control device 20 does not control the driver circuit 4′, which is electrically connected thereto, to decelerate the motor 5′, so that the motor 5′ keeps its rotary speed without being decelerated. The communication unit 24 of the second control device 20 performs the step S29 to transmit the second rotation number signal to the first control device 10, and then repeats the step S21. If the second rotation number signal is smaller than the first rotation number signal, the microcontroller 22 of the second control device 20 performs the step S28 to determine whether another difference signal has been outputted to the driver circuit 4′ to make the motor 5′ in a deceleration control; if no, the step S21 is repeated; if yes, the microcontroller 22 of the second control device 20 cancels the deceleration control to stop decelerating the motor, and the motor 5′ rotates in the speed before the deceleration control. After that, the communication unit 24 of the second control device 20 performs the step S29 to transmit the second rotation number signal to the first control device 10, and then repeats the step S21 until the first rotation number signal is equal to the second rotation number signal or the electric single beds reach the target locations.

An example is described below to specify the process of making the double electric bed perform synchronized motion. It is assumed that the input interface 30 is set to make the two electric single beds 2 and 2′ to swing synchronously, and the load on the electric single bed 2 controlled by the first control device 10 is heavier than that on the electric single bed 2′, so that the motor 5 rotates slower than the motor 5′. The first control device 10 performs the steps S11, S12, S13, S14 and S15 in order. After that, the second control device 20 performs the steps S21, S22, S26 and S27 to decelerate the motor 5′ controlled by the second control device 20, and then performs the step S29. After that, the first control device 10 performs the steps S11, S12 and S16. If the first rotation number signal is equal to the second rotation number signal, the two electric single beds 2 and 2′ perform synchronized motions. If the first rotation number signal is still smaller than the second rotation number signal, the first control device 10 performs the step S18 and then return to the step S11 to repeat the above-mentioned process until the first rotation number signal is equal to the second rotation number signal or the electric single beds 2 and 2′ reach the target locations.

Therefore, by feeding back the Hall signals corresponding to the rotations of the two motors 5 and 5′ to the first and second control devices 10 to enable the first and second control devices 10 and 20 to compare the first and second rotation number signals and respectively control the motors 5 and 5′ according to the comparison result, the objective of making the double electric bed 1 perform synchronized motion can be achieved. The way of achieving the synchronized motion by decelerating the motors 5 and 5′ has the following advantages. The first advantage is that decreasing the operating voltage to decelerate the motors 5 and 5′ can avoid the danger of the current overload. The second advantage is that the motors 5 and 5′ can rotate in relatively higher speed when the synchronized motions of the electric single beds 2 and 2′ are not required, so that operational efficiency of the electric single beds 2 and 2′ can be improved. The third advantage is that synchronizing the motions of the two electric single beds by decelerating the motors is beneficial to improve the mechanical tolerances of the two electric single beds. Especially for the loaded electric single bed, the motion with deceleration can decrease the stress impact applied on the electric single bed, so as to improve the mechanical tolerance.

It should be noted that after comparing the two rotation number signals, the microcontroller is not limited to output the difference signal, but may output another control signal, such as a true signal for controlling the driver circuit to decrease the output voltage by a predetermined voltage or a false signal for not changing the output voltage of the driver circuit.

In other embodiments, the way of making the double electric bed perform synchronized motion can be only decelerating the motor. However, the better way of that, as provided in this embodiment, is not only decelerating the motor, but may be canceling the deceleration control if the motor is under the deceleration control; in this way, the motion of the double electric bed can be synchronized more quickly.

In other embodiments, the communication unit can be combined with the microcontroller. For example, a microcontroller having communication function can be used to serve as the microcontroller and the communication unit of the present invention.

The above description represents merely the preferred embodiment of the present invention, without any intention to limit the scope of the present invention. The simple variations and modifications not to be regarded as a departure from the spirit of the invention are intended to be included within the scope of the following claims.

What is claimed is:

1. A synchronized motion control system for a double electric bed, the double electric bed comprising two electric single beds each having a driver circuit and a motor controlled by the driver circuit to drive motion of the electric single bed, the synchronized motion control system comprising:
two control devices attached to the electric single beds respectively, and each having a Hall sensor for being disposed in the motor of the electric single bed to generate a Hall signal which corresponds to rotation of the motor, a microcontroller electrically connected with the Hall sensor for generating a rotation number signal according to the Hall signal, and a communication unit electrically connected with the microcontroller for receiving the rotation number signal, the rotation number signal indicating accumulative changing times of the Hall signal;
wherein, the communication units of the control devices are electrically connected with each other, thereby enabling the microcontroller of one of the control devices to receive the rotation number signal of the other control device and compare the two rotation number signals of the two control devices to generate a difference signal; and
the microcontrollers are adapted for being electrically connected with the driver circuits of the electric single beds to output the difference signal to the driver circuit of the electric single bed which corresponds to the larger one of the rotation number signals of the two control devices, so that the driver circuit, which receives the difference signal, decelerates its corresponding said motor by decreasing output voltage according to the difference signal.

2. The synchronized motion control system according to claim 1, further comprising an input interface electrically connected with the communication units of the two control devices.

3. A synchronized motion control method for a double electric bed, the double electric bed comprising two electric single beds each having a driver circuit and a motor controlled by the driver circuit to drive motion of the electric single bed, the synchronized motion control method comprising the steps of:
(A) providing two Hall sensors located at the two motors respectively, and providing two microcontrollers electrically connected with the two Hall sensors respectively, wherein the two Hall sensors are adapted for generating two Hall signals which correspond to rotations of the motors respectively;
(B) using the two microcontrollers to calculate two rotation number signals according to the two Hall signals respectively, wherein the two rotation number signals indicate accumulative changing times of the two Hall signals respectively; and
(C) using one of the microcontrollers to determine whether the two rotation number signals are equal to each other, if the two rotation number signals are not equal to each other, controlling the driver circuits to decelerate the motor which corresponds to the larger one of the two rotation number signals.

4. The synchronized motion control method according to claim 3, wherein in the step (C), if the two rotation number signals are not equal to each other and the motor corresponding to the lower one of the two rotation number signals is under deceleration control, the driver circuits are controlled to cancel the deceleration control.

5. The synchronized motion control method according to claim 4, wherein the step (B) and the step (C) are repeated after the step (C).

6. The synchronized motion control method according to claim 3, wherein the step (B) and the step (C) are repeated after the step (C).

7. A synchronized motion control method for a double electric bed, the double electric bed comprising two electric single beds each having a driver circuit and a motor controlled by the driver circuit to drive motion of the electric single bed, the synchronized motion control method comprising the steps of:
(A) providing two control devices attached to the electric single beds respectively, wherein each of the two control devices comprises a Hall sensor, a microcontroller electrically connected with the Hall sensor, and a communication unit electrically connected with the microcontroller; the Hall sensors are disposed in the motors of the electric single beds respectively for generating two Hall signals which corresponds to rotations of the motors respectively; the microcontrollers are electrically connected with the driver circuits of the electric single beds respectively; the communication units of the control devices are electrically connected with each other;
(B) using the two microcontrollers to generate two rotation number signals according to the two Hall signals respectively, and using the communication units to receive the rotation number signals from the microcontrollers respectively and transmit the rotation number signals to each other, wherein the two rotation number signals indicate accumulative changing times of the two Hall signals respectively;
(C) using one of the microcontrollers to compare the two rotation number signals to generate a difference signal; and
(D) if the difference signal is not equal to zero, using the microcontroller used in the step (C) to output the difference signal to the driver circuit of the electric single bed which corresponds to the larger one of the rotation number signals and using the driver circuit, which receives the difference signal, to decelerate its corresponding said motor by decreasing output voltage according to the difference signal.

8. The synchronized motion control method according to claim 7, wherein in the step (D), if the microcontroller has outputted the difference signal to decelerate the motor corresponding to the lower one of the rotation number signals, the microcontroller stops outputting the difference signal to the motor corresponding to the lower one of the rotation number signals.

9. The synchronized motion control method according to claim 8, wherein in the step (C), if the difference signal equals zero, the microcontrollers stop controlling the driver circuits to decelerate the motors.

10. The synchronized motion control method according to claim 8, wherein the step (B) is repeated after the step (D).

11. The synchronized motion control method according to claim 10, wherein after the step (B) is repeated, the step (C) is performed by using the microcontroller other than the microcontroller used in the last step (C) to compare the two rotation number signals to generate a difference signal.

12. The synchronized motion control method according to claim 7, wherein in the step (C), if the difference signal equals zero, the microcontrollers stop controlling the driver circuits to decelerate the motors.

13. The synchronized motion control method according to claim 7, wherein the step (B) is repeated after the step (D).

14. The synchronized motion control method according to claim 13, wherein after the step (B) is repeated, the step (C) is performed by using the microcontroller other than the microcontroller used in the last step (C) to compare the two rotation number signals to generate a difference signal.
